(19) United States
(12) Patent Application Publication
(10) Pub. No.: US 2010/0244474 A1
(43) Pub. Date: Sep. 30, 2010

(54) Mechanical Grasping Device for a Fireplace

(76) Inventor: Mark Robert Kornely, Two Rivers, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/732,339

(22) Filed: Mar. 26, 2010

Related U.S. Application Data
(60) Provisional application No. 61/164,003, filed on Mar. 27, 2009.

(51) Int. Cl. F24B 15/00; B25J 1/00; B25J 1/04; A47F 13/06; F24B 15/10

(52) U.S. Cl. 294/11; 294/19.1

(57) ABSTRACT

The present invention is a mechanical grasping device for fireplaces, specifically for manipulating and moving burning logs, embers and other hot elements in or near a fireplace. The present invention includes a hollow tubular structure, a solid rod that runs inside the length of the hollow tubular member, a looped handle that rotates attached to one end of solid rod, and pivotal and stationary grasping prongs located at the end opposite looped handle.

### CROSS-REFERENCE TO RELATED APPLICATIONS

This application claims priority to U.S. Provisional Application No. 61/164,003 filed on Mar. 27, 2009.

### FIELD OF INVENTION

The present invention relates generally to the field of fireplace tongs, and more specifically to a torque-activated fireplace component.

### BRIEF DESCRIPTION OF THE DRAWINGS

FIG. 1 illustrates a perspective view of an exemplary embodiment of a mechanical grasping device for a fireplace which utilizes a torque force for grasping.

FIG. 2 illustrates a perspective view of an exemplary embodiment of the curved prongs of a mechanical grasping device for a fireplace.

### GLOSSARY

As used herein, the term “cold rolled steel” refers to steel which is formed at a temperature below its recrystallization temperature (e.g., room temperature).

As used herein, the term “curved prong” refers to a thin, contoured structure having at least one bend and adapted for grasping objects. Curved prongs may also be pointed.

As used herein, the term “fireplace” refers to an indoor or outdoor fireplace.

As used herein, the term “powder coating” refers to particles applied as a free-flowing, dry powder to create a coating on the surface of an object.

As used herein, the term “rotatable” means capable of being turned.

As used herein, the term “rod structure” refers to a component that runs inside the length of the tubular structure yet can rotate freely within the tubular structure. In various embodiments, rod structure may have a curved prong at one end and a rotatable handle at the other end.

As used herein, the term “serrated edges” refers to a boundary line of an object that is notched or jagged.

As used herein, the term “target object” refers to a burning log, ember, or another hot element within or in close proximity to a fireplace.

As used herein, the term “torque force” means strength or pressure exerted on an object which causes rotation or torsion.

As used herein, the term “tubular structure” refers to a hollow or substantially hollow structure made of metal or other fire resistant material.

### BACKGROUND

There have been many attempts in the prior art to develop a mechanical grasping device for use in fireplaces (which may include both traditional indoor fireplaces and outdoor fireplaces) for manipulating burning logs, embers and other hot elements within or in close proximity to a fireplace.

Implements known in the prior art generally require a user to place himself or herself uncomfortably close to the heat and flames produced in the fireplace in order to periodically rearrange the combustibles and keep the fire going.

Additionally, implements known in the prior art generally require a user to exert a great deal of energy to manipulate larger logs, including exerting torque force. Commercially available fireplace implements also lack the structural capability to hold logs, embers and other hot materials securely.

Many attempts have been made to solve the foregoing problems. For example, U.S. Patent Application No. 2007/0046046 (Camp '046) teaches an implement that requires only one hand for operation. The implement taught in Camp '046 includes a tubular shaft construction and a design that utilizes torque forces for moving logs. However, this apparatus lacks the structural capability to securely grip hot logs, embers and other objects.

Similarly, U.S. Design Patent No. D115574 (Havermeyer '574) teaches a device comprised of metal rods and three gripping teeth designed to move logs inside a fire or fireplace. However, the device taught by Havermeyer '574 requires the user to utilize considerable force, and the metal rods may become hot and burn a user's hands.

U.S. Patent Application No. 2001/0045504 (Kopal '504) also teaches a metal device with two gripping teeth designed to move burning wood or embers around in a fireplace. The teeth clamp a target object when a wooden handle is compressed, which slides a center bar (connected to the gripping teeth) back and forth.

U.S. Pat. No. 4,176,871 (Stover '871) teaches a device for manipulating logs in a fireplace which utilizes two stationary teeth and one movable tooth on the opposing side.

One device, called The Log Turner, is sold at www.thelogtumer.com/. This device attempts to use the torque force of opposing rotatable pieces of tubing. However, this device has several limitations. The rounded tubing is heavy, slippery and structurally weak, which means The Log Turner must be approximately 60 inches in length to obtain the leverage needed to lift a log using the hollow tubular structure.

Moreover, The Log Turner is not adapted to resist deformation of the tubular components and painted surface in high temperatures. The Log Turner is heavy, and is ineffective for gripping logs because it relies only on the pressure caused by two opposing gripping components.

It is desirable to increase the functionality of a log grasping device by using appropriate curvature, assembly, heat resistant materials and frictional elements to maximize leverage, torque force and overall gripping.

It is further desirable for a log grasping device to have a structural design which minimizes the weight and length necessary to achieve sufficient strength to allow the apparatus to maximize leverage and torque force.

### SUMMARY OF THE INVENTION

The present invention is a mechanical grasping device for fireplaces, specifically for manipulating and moving burning logs, embers and other heated elements in or near a fireplace. The mechanical grasping device is comprised of a rod structure with a single curved prong attached to one end and a rotatable handle attached to the other, a hollow tubular structure which has sufficient diameter to enclose the rod structure and allow it to freely rotate, and a u-shaped prong member with two curved prongs that is attached to the end of hollow tubular structure. Turning rotatable handle causes single curved prong to move toward or away from u-shaped prong member to grasp or release burning logs, embers and other heated elements. The length and weight of the present invention allows the user to keep a safe distance from heat, smoke and flames while maximizing leverage when adjusting the position of heated elements within the fireplace.

### DETAILED DESCRIPTION OF THE DRAWINGS

For the purpose of promoting an understanding of the present invention, references are made in the text to exemplary embodiments of a mechanical grasping device for a fireplace, only some of which are described herein. It should be understood that no limitations on the scope of the invention are intended by describing these exemplary embodiments. One of ordinary skill in the art will readily appreciate that alternate but functionally equivalent components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

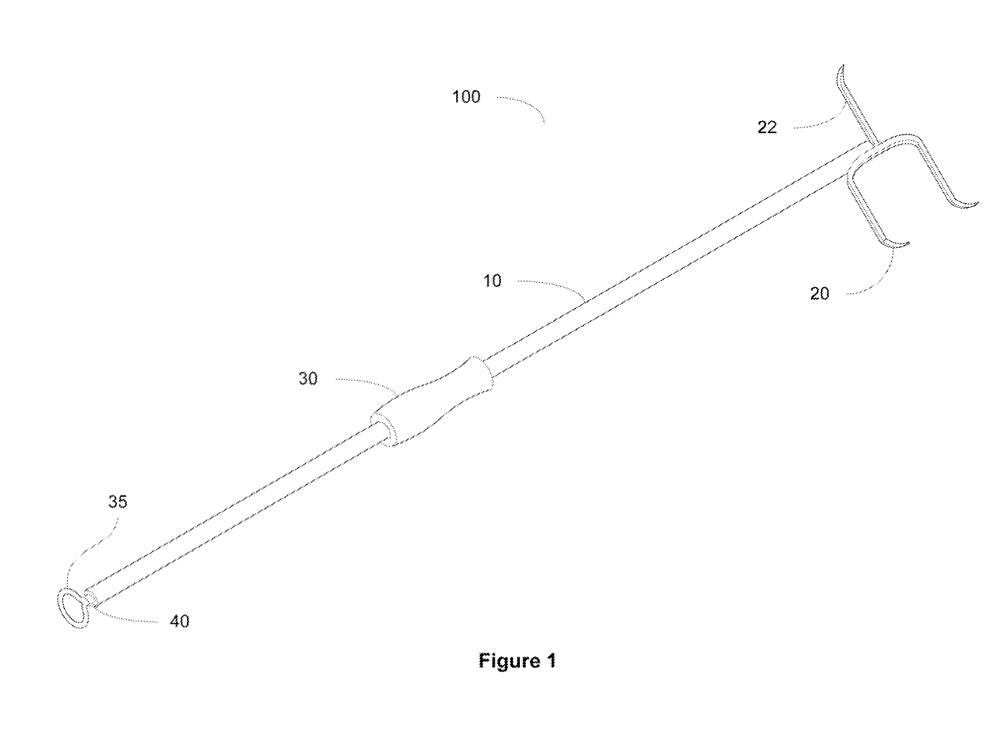

FIG. 1 is a perspective view of an exemplary embodiment of mechanical grasping device for a fireplace 100. Mechanical grasping device for a fireplace 100 includes hollow tubular structure 10, which in the embodiment shown weighs less than five (5) pounds and is approximately forty-eight (48) inches long, but may be of any length to provide sufficient leverage and length for a user to maintain a safe and comfortable distance from a fireplace and hot elements such as logs and embers. For example, an alternative embodiment may include a tubular structure ranging from thirty-two (32) to fifty (50) inches in length.

Mechanical grasping device for a fireplace 100 further includes rod structure 40 which is inserted within hollow tubular structure 10. U-shaped prong member 20, which is comprised of two curved prongs, is fixedly attached to the outer surface near the end of hollow tubular structure 10. U-shaped prong member 20 is stationary and does not move during use of mechanical grasping device for a fireplace 100. In the embodiment shown, u-shaped prong member 20 is welded to the end of tubular structure 10, but in other embodiments may be secured using another means, such as by a fastening or clamping device.

In the embodiment shown, mechanical grasping device for a fireplace 100 is comprised of cold rolled steel and black pipe known in the art and has a layer of powder coating which adds additional texture to the surface of mechanical grasping device for a fireplace 100. These materials are superior to other types of steel conventionally known in the art because of their minimized deformation and maximized strength.

Also shown in FIG. 1 is single curved prong 22 which is fixedly attached near the end of rod structure 40. At the end of hollow tubular structure 10 opposite U-shaped prong member 20 and single curved prong 22 is rotatable handle 35 which is manipulated by the user to move single curved prong 22. Rotatable handle 35 is connected to single curved prong 22 by rod structure 40 which runs the length of hollow tubular structure 10. When rotatable handle 35 is rotated clockwise by the user, rod structure 40 rotates clockwise within hollow tubular structure 10 rotating single curved prong 22 clockwise toward u-shaped prong member 20. This allows u-shaped prong member 20 and single curved prong 22 to clinch around a target object. Conversely, rotating rotatable handle 35 counterclockwise will cause single curved prong 22 to rotate counterclockwise and away from u-shaped prong member 20, opening single curved prong 22 and releasing a target object.

In the embodiment shown, single curved prong 22 and rotatable handle 35 are welded to rod structure 40, however, in other embodiments may be secured using another means known in the art or may be integrally molded with rod structure 40. In the embodiment shown, rotatable handle 35 is looped, but in other embodiments may be square, T-shaped, contoured or of any shape which can be easily turned by a user.

In the embodiment shown, rod structure 40 is approximately the same length or slightly longer than hollow tubular structure 10, e.g., rod structure is forty-nine (49) inches long. In other embodiments, rod structure 40 and hollow tubular structure 10 may be telescoping allowing the user to adjust their length and/or may be capable of being disassembled (e.g., comprised of smaller components that are secured together) for cleaning and stowing.

In the embodiment shown, u-shaped prong member 20 and single curved prong 22 have flattened edges and are approximately six (6) to ten (10) inches long; however, in other embodiments may be of varying shapes, such as rounded (i.e., no flattened edges) or semicircular, longer or shorter, of varying lengths, and/or have serrated edges.

In the embodiment shown, rod structure 40, hollow tubular structure 10, single curved prong 22, and u-shaped prong member 20 are comprised of cold rolled steel, but in other embodiments may be comprised of iron, brass, copper, pewter, nickel, bronze, lead, another heat-resistant metal or material, or combinations thereof.

In the embodiment shown, mechanical grasping device for a fireplace 100 further includes grasping component 30 for grasping hollow tubular structure 10. If a user is right handed, the user may hold rotatable handle 35 with his or her right hand and grasping component 30 with his or her left hand. Grasping component 30 protects the user's hand from being burned as u-shaped prong member 22 and single curved prong 22 will gradually transfer heat from a fire to hollow tubular structure 10 and rod structure 40.

Single curved prong 22 may be embedded (dug) into the surface of a piece wood or other object reducing the leverage force and gripping tension necessary to grasp and lift larger, heavier logs. Moreover, the textured powder coated surface provides additional friction to keep to the log from sliding, and the cold rolled steel prevents deformation at high temperatures.

In the embodiment shown, grasping component 30 is comprised of wood and is fixedly attached to hollow tubular structure 10. In various embodiments, grasping component 30 may be slidingly attached to hollow tubular structure 10, may be made of another material that will not conduct sufficient heat to burn a user's hand, and/or may be flame retardant. In still other embodiments, grasping component 30 may be contoured or be of another design. For example, grasping component 30 could be a lever which extends perpendicular from hollow tubular structure 10.

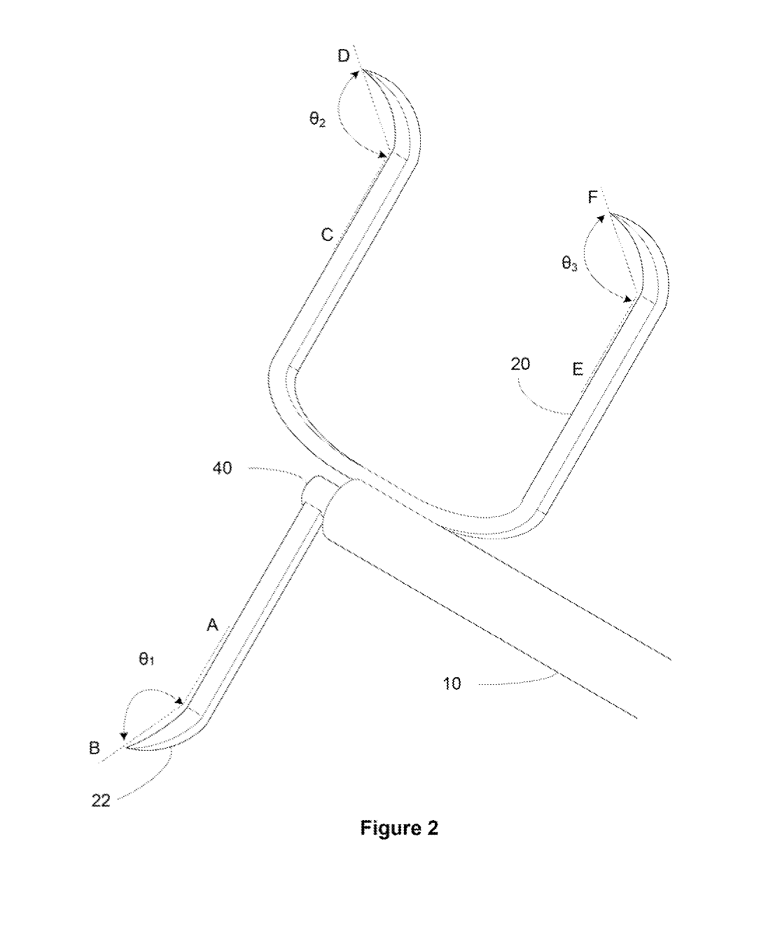

FIG. 2 is a perspective view of an exemplary embodiment of u-shaped curved prong 20 and single curved prong 22. Also visible are the ends of hollow tubular structure 10 and rod structure 40.

As rod structure 40 rotates inside hollow tubular structure 10, single curved prong 22, which is connected to rod structure 40, rotates. A burning log, ember or other hot element can then be grasped between u-shaped prong member 20 (stationary) and single curved prong 22.

Curved prong 22 has angle θ₁ (angle between lines A and B) and the curved prongs of u-shape prong member 20 have angles θ₂ (angle between lines C and D) and θ₃ (angle between lines E and F). Angles θ₁, θ₂, θ₃ are optimized to maximize leverage and conform to the shape of a log. In various embodiments, angles θ₁, θ₂, θ₃ may range from 45 to 175 degrees and/or may be of varying degrees.

What is claimed is:

1. A grasping apparatus comprised of:
a rod structure having a first end and a second end;
a first curved prong fixedly attached at said first rod end, said curved prong having angle θ₁, said θ₁ ranging from 45 to 175 degrees;
a rotatable handle fixedly attached to said second end of said rod structure;
a hollow tubular structure adapted to enclose said rod structure, said hollow tubular structure having a sufficient diameter to allow said rod structure to freely rotate inside said hollow tubular structure; and
a u-shaped prong member having a second curved prong having angle θ₂ and a third curved prong having angle θ₃, said u-shaped prong member fixedly attached to the outer surface of said hollow tubular structure.

2. The apparatus of claim 1 which further includes a heat resistant grasping component adapted to encircle said hollow tubular structure.

3. The apparatus of claim 2 wherein said heat resistant grasping component is made of wood.

4. The apparatus of claim 1 wherein said apparatus is powder coated and constructed of cold rolled steel to minimize deformation and maximize strength.

5. The apparatus of claim 1 wherein all surfaces are textured.

6. The apparatus of claim 1 wherein said first curved prong and said u-shaped prong member have a least one flattened surface for a log to rest.

7. The apparatus of claim 1 wherein said first curved prong is integrally molded with said rod structure and includes a point capable of pentrating a surface of a log.

8. The apparatus of claim 1 wherein said rod structure, said hollow tubular structure, said first curved prong, and said u-shaped prong member are comprised of a material selected from a group consisting of steel, iron, brass, copper, pewter, nickel, bronze, lead, and combinations thereof.

9. The apparatus of claim 1 wherein when said rotatable handle is rotated clockwise, said first curved prong rotates clockwise toward said u-shaped prong member to grasp a target object, and when said rotatable handle is rotated counterclockwise, said first curved prong rotates counterclockwise and away from said u-shaped prong member to release a target object.

10. The apparatus of claim 1 wherein said hollow tubular structure is 36 to 50 inches long.

11. The apparatus of claim 1 wherein said angle θ₁, said angle θ₂, and said angle θ₃ range from 120 to 150 degrees.

12. The apparatus of claim 1 wherein said angle θ₁, said angle θ₂, and said angle θ₃ are of varying degrees and are optimized relative to each other.

13. The apparatus of claim 2 wherein said heat resistant grasping component is a lever perpendicular placed.

14. The apparatus of claim 2 wherein said heat resistant grasping component is contoured.

15. The apparatus of claim 1 wherein is said hollow tubular structure and said rod structure are telescoping.

16. The apparatus of claim 1 which further includes a second u-shaped prong member.

17. The apparatus of claim 1 wherein said first curved prong, said second curved prong and said third curved prong have serrated edges.

18. The apparatus of claim 1 wherein said first curved prong, said second curved prong and said third curved prong are semicircular.

19. The apparatus of claim 1 wherein said rotatable handle has a grasping end with a shape selected from a group consisting of t-shaped, I-shaped, angle shaped, looped, cylindrical and c-shaped.

20. The apparatus of claim 1 wherein said apparatus has a total weight of less than five pounds.
